(19) United States
(12) Patent Application Publication
(10) Pub. No.: US 2026/0277586 A1
(43) Pub. Date: Sep. 17, 2026

(54) INFORMATION PROCESSING SYSTEM, NON-TRANSITORY COMPUTER READABLE MEDIUM AND INFORMATION PROCESSING METHOD

(71) Applicant: FUJIFILM Business Innovation Corp., Tokyo (JP)

(72) Inventors: Junya YAMADA, Kanagawa (JP); Binhui LIU, Kanagawa (JP); Takeshi HORIGUCHI, Kanagawa (JP); Kazuaki MORITO, Kanagawa (JP); Kota SAKURAI, Kanagawa (JP); Riku SHIMAURA, Kanagawa (JP); Atsuya BABA, Kanagawa (JP)

(73) Assignee: FUJIFILM Business Innovation Corp., Tokyo (JP)

(21) Appl. No.: 19/267,948

(22) Filed: Jul. 14, 2025

(30) Foreign Application Priority Data
Mar. 12, 2025 (JP) 2025-039463

(51) Int. Cl. G06F 8/65; H04N 1/00

(52) U.S. Cl. CPC G06F 8/65; H04N 1/0097

(57) ABSTRACT

An information processing system includes a processor configured to: when update information on the information processing apparatus is received, display to a general user the update information and an operator used to input an update request; and display to an administrative user the update information, result information on the update request input by the general user, and an operator used to input an update execution instruction.

### CROSS-REFERENCE TO RELATED APPLICATIONS

This application is based on and claims priority under 35 USC 119 from Japanese Patent Application No. 2025-039463 filed Mar. 12, 2025.

### BACKGROUND

### (i) Technical Field

The present disclosure relates to an information processing system, a non-transitory computer readable medium and an information processing method.

### (ii) Related Art

Japanese Unexamined Patent Application Publication No. 2005-228200 discloses an electronic apparatus having a firmware update function that enables an administrator of the electronic apparatus to determine whether firmware is to be updated or not and enables the administrator to set an update timing in view of a usage state of the electronic apparatus.

Japanese Unexamined Patent Application Publication No. 2008-172326 discloses an information processing apparatus that displays a function not available thereon and stores on an external device the number of times requested so that the information processing apparatus may learn a function a user wants to use.

### SUMMARY

Aspects of non-limiting embodiments of the present disclosure relate to providing an information processing system, a non-transitory computer readable and an information processing method that may receive an update request from a general user who has no right to update the information processing system.

Aspects of certain non-limiting embodiments of the present disclosure address the above advantages and/or other advantages not described above. However, aspects of the non-limiting embodiments are not required to address the advantages described above, and aspects of the non-limiting embodiments of the present disclosure may not address advantages described above.

According to an aspect of the present disclosure, there is provided an information processing system including a processor configured to: when update information on the information processing apparatus is received, display to a general user the update information and an operator used to input an update request; and display to an administrative user the update information, result information on the update request input by the general user, and an operator used to input an update execution instruction.

### BRIEF DESCRIPTION OF THE DRAWINGS

Exemplary embodiment of the present disclosure will be described in detail based on the following figures, wherein:

FIG. 1 is an external view of an image forming apparatus according to an exemplary embodiment of the disclosure;

FIG. 2 is a block diagram illustrating the hardware configuration of the image forming apparatus;

FIG. 3 illustrates an example of an information confirmation screen for a general user;

FIG. 4 illustrates an example of an information confirmation screen for an administrative user;

FIG. 5 illustrates a process performed when the image forming apparatus has received update information;

FIG. 6 is a flowchart illustrating a flow of a display process of information confirmation screen for the administrative user; and

FIG. 7 is a flowchart illustrating a flow of a display process of information confirmation screen for the general user.

### DETAILED DESCRIPTION

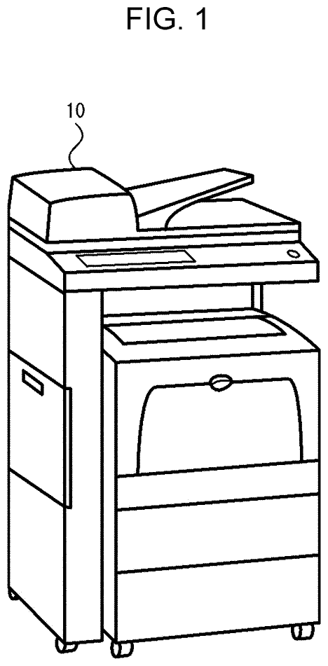

Exemplary embodiment of the disclosure is described in detail with reference to the drawings. FIG. 1 is an external view of an image forming apparatus 10 of an exemplary embodiment of the disclosure.

The image forming apparatus 10 illustrated in FIG. 1 is a multi-function apparatus having a copying function, printing function, fax function, scan functions and the like. The image forming apparatus 10 is an example of an information processing system in the technique of the exemplary embodiment of the disclosure.

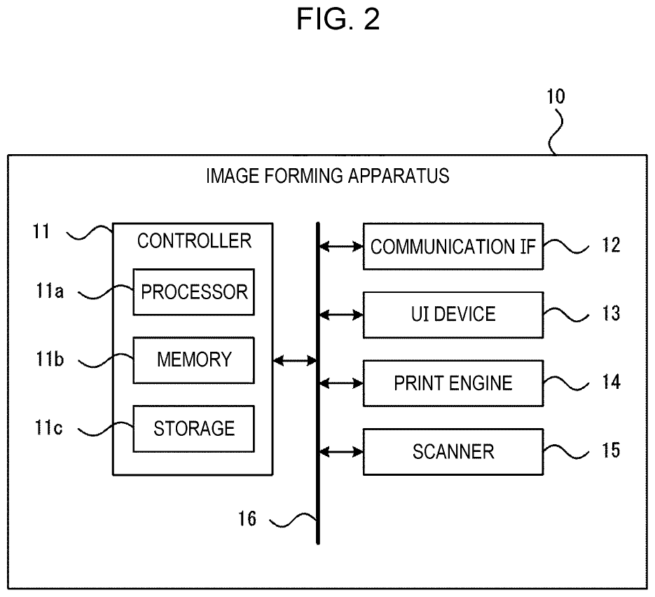

The hardware configuration of the image forming apparatus 10 of the exemplary embodiment is described below. FIG. 2 is a block diagram illustrating the hardware configuration of the image forming apparatus 10.

Referring to FIG. 2, the image forming apparatus 10 includes a controller 11, communication interface (IF) 12, user interface (UI) device 13, print engine 14, and scanner 15. These elements are connected to each other via a control bus 16.

The controller 11 includes a processor 11a, memory 11b and storage 11c. The processor 11a performs a predetermined process in accordance with a program retrieved from the storage 11c and loaded onto the memory 11b. The storage 11c may be a read-only memory (ROM), hard-disk drive (HDD), solid-state drive (SSD) or the like. The storage 11c stores a variety of programs, data and the like.

According to the exemplary embodiment described above, the processor 11a retrieves the program from the storage 11c to perform the program. The disclosure is not limited to this method. The program may be supplied in a recorded form on a computer readable recording medium. Also, the program may be retrieved from an external apparatus via a communication network.

The communication IF 12 transmits data to or receives data from an external apparatus or the like. The UI device 13 includes, for example, a touch panel and/or a button and a user receives or inputs information using the UI device 13. The print engine 14 prints an image on a recording medium, such as a paper sheet, via steps including charging, exposure, development, transfer, and fixing. The scanner 15 reads an original document loaded on the image forming apparatus 10 and outputs image data in a set image format.

When update information on the image forming apparatus 10, such as update information on firmware, is received, the image forming apparatus 10 of the exemplary embodiment is configured to receive an update request from a general user having no right to update the image forming apparatus 10.

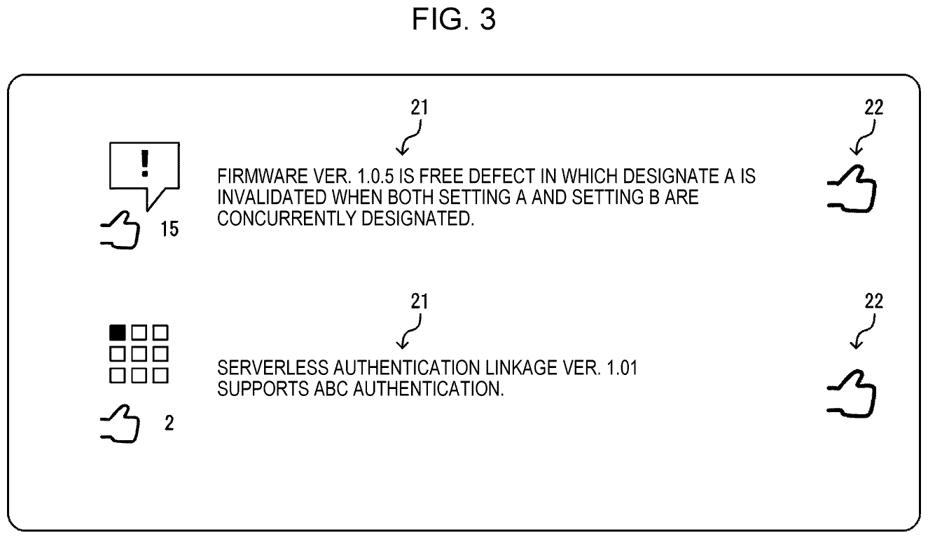

Upon receiving the update information on the image forming apparatus 10 from an external management server or the like, the controller 11 in the image forming apparatus 10 of the exemplary embodiment displays an information confirmation screen on a touch panel. As illustrated in FIG. 3, the controller 11 then displays, to the general user on the information confirmation screen, update information 21 and an operator 22 used to input an update request.

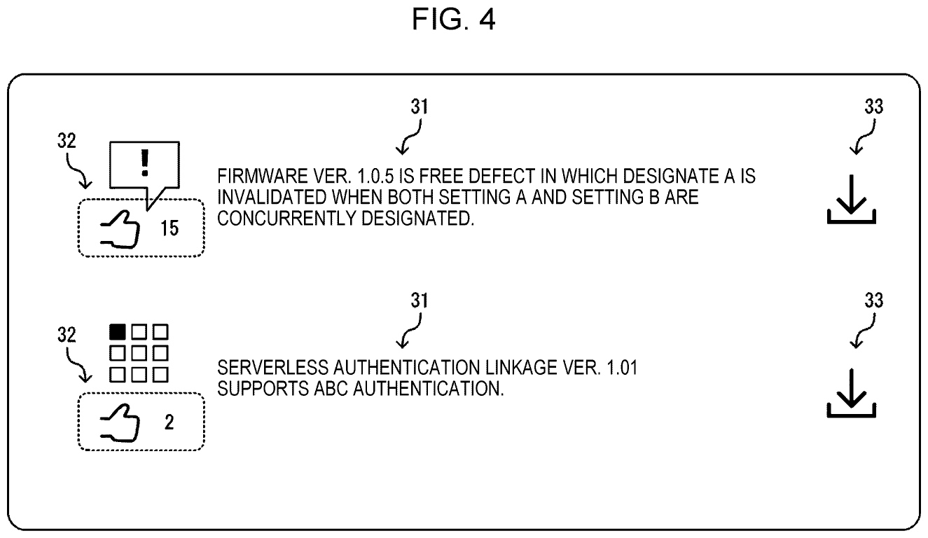

As illustrated in FIG. 4, the controller 11 also displays, to an administrative user on the information confirmation screen, update information 31, result information 32 on the update request input by the general user and an operator 33 used to input an update execution instruction.

The controller 11 displays the number of update requests as the result information 32 on the update requests input by the general user. As illustrated in FIG. 3, the controller 11 may also display the result information on the update requests to the general user.

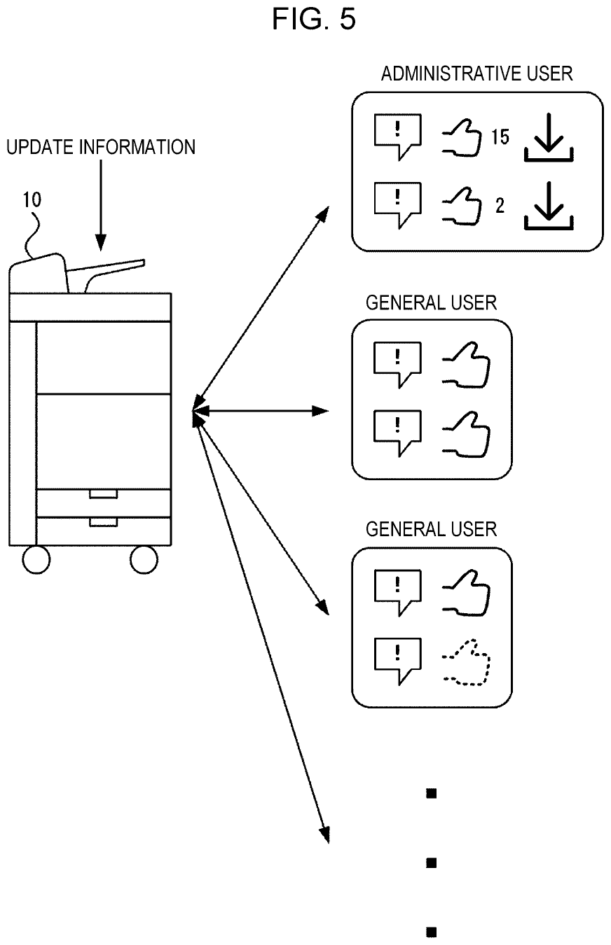

The controller 11 in the image forming apparatus 10 of the exemplary embodiment sorts the results of update requests input by multiple general users and then display the sorted results to the administrative user as illustrated in FIG. 5. In this way, the administrative user may learn the update requests from the general users.

When the update information on the image forming apparatus 10 is received in the exemplary embodiment, the controller 11 may display to the general user an entry box used to receive a comment and the operator 22 used to input the update request while displaying to the administrative user the number of update requests and the comments input by the general user as the result information 32 on update request inputs by the general user.

The controller 11 may display to the general user an operator used to input a non-update request, operator 22 used to input the update request, and entry box used to receive the comment while also displaying to the administrative user the number of update requests, number of non-update requests, and the comment input by the general user as the result information 32 on the update requests input by the general user.

The controller 11 may further display to the general user an operator used to input an update pending request, operator 22 used to input the update request, operator used to input the non-update request, and entry box used to receive the comment while displaying to the administrative user the number of update requests, number of non-update requests, number of update pending requests, and comment input by the general user as the result information 32 on update requests input by the general user.

The controller 11 may also display a percentage of the number of update requests as the result information 32 on update requests input by the general user. The population on which the percentage of the number of update requests is based may be the total number of general users or the number of users who have input update requests.

In this case, the controller 11 may receive from the administrative user the percentage of the number of update requests when updating is performed while displaying to the general user the percentage of the number of update requests when the updating is performed.

When the percentage of the number of update requests exceeds the percentage input by the administrative user, the controller 11 may be configured to be able to perform the updating without receiving an update instruction from the administrative user.

Upon updating an item of the update request input by the general user, the controller 11 may notify the general user that the item has been updated. In this case, any form of notification may be acceptable, for example, the notification may be displayed on the touch panel.

The controller 11 may receive a change of information on the update request input by the general user.

The controller 11 may share information on the update request with other image forming apparatuses.

When the number of update requests input by the general user exceeds a threshold, the controller 11 may notify the administrative user that the number of update requests has exceeded the threshold. In this case, any form of notification may be acceptable, for example, the notification may be displayed on the touch panel.

The controller 11 may switch in response to contents of updating whether to display to the general user the update information and operator used to input the update request.

When the contents of updating are related to correcting a defect in the image forming apparatus 10, the controller 11 may not necessarily display to the general user the update information and operator used to input the update request.

The flow of a display process of the information confirmation screen in the image forming apparatus 10 is described below.

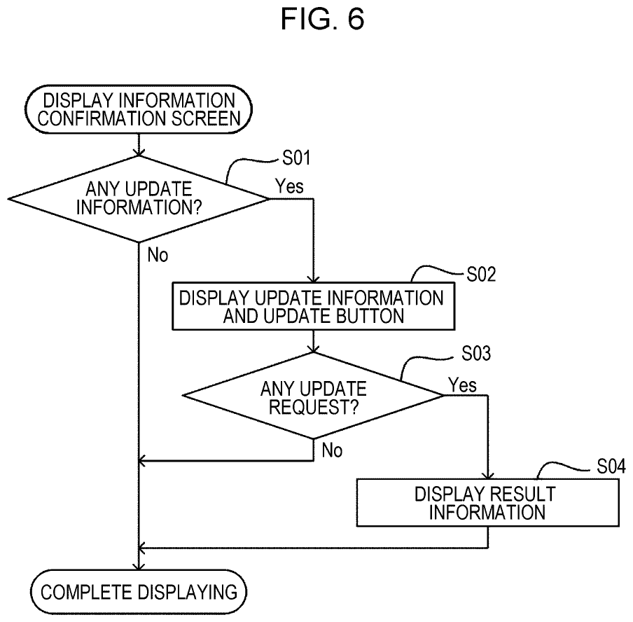

FIG. 6 is a flowchart illustrating the flow of the display process of an information confirmation screen for the administrative user.

The controller 11 determines in step S01 whether update information is present when the information confirmation screen is displayed.

If the controller 11 determines in step S01 that no update information is present, the controller 11 completes displaying.

If the controller 11 determines in step S01 that update information is present, the controller 11 displays in step S02 the update information 31 and an update button as the operator 33 used to input an update execution instruction.

The controller 11 determines in step S03 whether an update request is provided by the general user.

If the controller 11 determines in step S03 that no update request is present, the controller 11 completes displaying.

If the controller 11 determines in step S03 that an update request is provided, the controller 11 displays the result information 32 on the update request input by the general user in step S04 and then completes displaying.

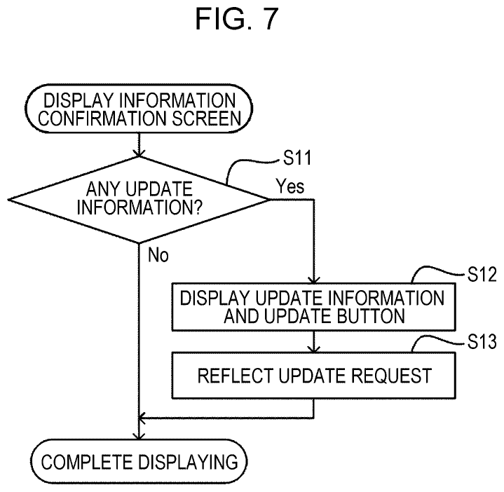

FIG. 7 is a flowchart illustrating the flow of a display process of the information confirmation screen for the general user.

The controller 11 determines in step S11 whether update information is present when the information confirmation screen is displayed.

If the controller 11 determines in step S11 that no update information is present, the controller 11 completes displaying.

If the controller 11 determines in step S11 that update information is present, the controller 11 displays in step S12 the update information 21 and a request button as the operator 22 used to input an update request.

In step S13, the controller 11 reflects the update request input by the general user and completes displaying.

### Modifications

The image forming apparatus 10 has been described as the exemplary embodiment of the disclosure and the technique in the disclosure is not limited to the exemplary embodiment and may be appropriately modified.

In the embodiments above, the term “processor” refers to hardware in a broad sense. Examples of the processor include general processors (e.g., CPU: Central Processing Unit) and dedicated processors (e.g., GPU: Graphics Processing Unit, ASIC: Application Specific Integrated Circuit, FPGA: Field Programmable Gate Array, and programmable logic device).

In the embodiments above, the term “processor” is broad enough to encompass one processor or plural processors in collaboration which are located physically apart from each other but may work cooperatively. The order of operations of the processor is not limited to one described in the embodiments above, and may be changed.

The “system” in the exemplary embodiment may be configured to include a single apparatus or multiple apparatuses.

The technique of the disclosure may be applicable to a program or a program product.

The foregoing description of the exemplary embodiments of the present disclosure has been provided for the purposes of illustration and description. It is not intended to be exhaustive or to limit the disclosure to the precise forms disclosed. Obviously, many modifications and variations will be apparent to practitioners skilled in the art. The embodiments were chosen and described in order to best explain the principles of the disclosure and its practical applications, thereby enabling others skilled in the art to understand the disclosure for various embodiments and with the various modifications as are suited to the particular use contemplated. It is intended that the scope of the disclosure be defined by the following claims and their equivalents.

### Appendix

(((1)))

An information processing system including:
a processor configured to:
   when update information on the information processing apparatus is received, display to a general user the update information and an operator used to input an update request; and
   display to an administrative user the update information, result information on the update request input by the general user, and an operator used to input an update execution instruction.
(((2)))

In the information processing system according to (((1))), the processor is configured to display a number of update requests as the result information on the update requests input by the general user.
(((3)))

In the information processing system according to (((1))), the processor is configured to:
when the update information on the information processing system is received, display to the general user an entry box used to receive a comment and the operator used to input the update request; and
display to the administrative user a number of update requests and the comment input by the general user, as the result information on the update requests input by the general user.
(((4)))

In the information processing system according to (((3))), the processor is configured to:
when the update information on the information processing system is received, display to the general user an operator used to input a non-update request, the operator used to input the update request, and the entry box used to receive the comment; and
display to the administrative user the number of update requests, a number of non-update requests, and the comment input by the general user, as the result information on the update requests input by the general user.
(((5)))

In the information processing system according to (((4))), the processor is configured to:
when the update information on the information processing system is received, display to the general user an operator used to input an update pending request, the operator used to input the update request, the operator used to input the non-update request, and the entry box used to receive the comment; and
display to the administrative user the number of update requests, the number of non-update requests, a number of update pending requests, and the comment input by the general user, as the result information on the update requests input by the general user.
(((6)))

In the information processing system according to one of (((2))) through (((5))), the processor is configured to display a percentage of the number of update requests as the result information on the update requests input by the general user.
(((7)))

In the information processing system according to (((6))), the processor is configured to:
receive from the administrative user the percentage of the number of update requests when updating is performed; and
display to the general user the percentage of the number of update requests when the updating is performed.
(((8)))

In the information processing system according to (((7))), the processor is configured to enable setting that performs the updating without receiving an update instruction from the administrative user when the percentage of the number of update requests exceeds a percentage input by the administrative user.
(((9)))

In the information processing system according to one of (((1))) through (((8))), the processor is configured to, when an item for which the general user has input the update request is updated, notify the general user that the item has been updated.
(((10)))

In the information processing system according to one of (((1))) through (((9))), the processor is configured to receive a change of information related to the update request input by the general user.
(((11)))

In the information processing system according to one of (((1))) through (((10))), the processor is configured to share information on the update request with other information processing systems.
(((12)))

In the information processing system according to one of (((1))) through (((11))), the processor is configured to, when a number of update requests input by the general user exceeds a set threshold, notify the administrative user that the number of update requests has exceeded the set threshold.
(((13)))

In the information processing system according to one of (((1))) through (((12))), the processor is configured to, in response to contents of updating, switch whether to display to the general user the update information and the operator used to input the update request.
(((14)))

In the information processing system according to (((13))), the processor is configured to, when the contents of the updating are used to correct a defect in the information processing system, not display to the general user the update information and the operator used to input the update request.
(((15)))

A program causing a computer to execute a process for processing information, the process including:
when update information on the information processing apparatus is received, displaying to a general user the update information and an operator used to input an update request; and
displaying to an administrative user the update information, result information on the update request input by the general user, and an operator used to input an update execution instruction.

What is claimed is:

1. An information processing system comprising:
a processor configured to:
when update information on the information processing apparatus is received, display to a general user the update information and an operator used to input an update request; and
display to an administrative user the update information, result information on the update request input by the general user, and an operator used to input an update execution instruction.

2. The information processing system according to claim 1, wherein the processor is configured to display a number of update requests as the result information on the update requests input by the general user.

3. The information processing system according to claim 1, wherein the processor is configured to:
when the update information on the information processing system is received, display to the general user an entry box used to receive a comment and the operator used to input the update request; and
display to the administrative user a number of update requests and the comment input by the general user, as the result information on the update requests input by the general user.

4. The information processing system according to claim 3, wherein the processor is configured to:
when the update information on the information processing system is received, display to the general user an operator used to input a non-update request, the operator used to input the update request, and the entry box used to receive the comment; and
display to the administrative user the number of update requests, a number of non-update requests and the comment input by the general user, as the result information on the update requests input by the general user.

5. The information processing system according to claim 4, wherein the processor is configured to:
when the update information on the information processing system is received, display to the general user an operator used to input an update pending request, the operator used to input the update request, the operator used to input the non-update request, and the entry box used to receive the comment; and
display to the administrative user the number of update requests, the number of non-update requests, a number of update pending requests, and the comment input by the general user as the result information on the update requests input by the general user.

6. The information processing system according to claim 2, wherein the processor is configured to display a percentage of the number of update requests as the result information on the update requests input by the general user.

7. The information processing system according to claim 6, wherein the processor is configured to:
receive from the administrative user the percentage of the number of update requests when updating is performed; and
display to the general user the percentage of the number of update requests when the updating is performed.

8. The information processing system according to claim 7, wherein the processor is configured to enable setting that performs the updating without receiving an update instruction from the administrative user when the percentage of the number of update requests exceeds a percentage input by the administrative user.

9. The information processing system according to claim 1, wherein the processor is configured to, when an item for which the general user has input the update request is updated, notify the general user that the item has been updated.

10. The information processing system according to claim 1, wherein the processor is configured to receive a change of information related to the update request input by the general user.

11. The information processing system according to claim 1, wherein the processor is configured to share information on the update request with other information processing systems.

12. The information processing system according to claim 1, wherein the processor is configured to, when a number of update requests input by the general user exceeds a set threshold, notify the administrative user that the number of update requests has exceeded the set threshold.

13. The information processing system according to claim 1, wherein the processor is configured to, in response to contents of updating, switch whether to display to the general user the update information and the operator used to input the update request.

14. The information processing system according to claim 13, wherein the processor is configured to, when the contents of the updating are used to correct a defect in the information processing system, not display to the general user the update information and the operator used to input the update request.

15. A non-transitory computer readable medium storing a program causing a computer to execute a process for processing information, the process comprising:
when update information on the information processing apparatus is received, displaying to a general user the update information and an operator used to input an update request; and
displaying to an administrative user the update information, result information on the update request input by the general user, and an operator used to input an update execution instruction.

16. An information processing method comprising:
when update information on the information processing apparatus is received, displaying to a general user the update information and an operator used to input an update request; and
displaying to an administrative user the update information, result information on the update request input by the general user, and an operator used to input an update execution instruction.
